(19) United States
(12) Patent Application Publication
(10) Pub. No.: US 2003/0209912 A1
(43) Pub. Date: Nov. 13, 2003

(54) Wind power electrical generating system

(76) Inventor: Randall Badger, Fort Pierce, FL (US)

Correspondence Address: Kevin Redmond, 6960 SW Gator Trail, Palm City, FL, 34990, US

(21) Appl. No.: 10/430,155

(22) Filed: May 6, 2003

Related U.S. Application Data
(60) Provisional application No. 60/377,828, filed on May 7, 2002.

(51) Int. Cl. F03D 9/00; H02P 9/04

(52) U.S. Cl. 290/55

(57) ABSTRACT

A Savonius rotor electrical generating system which includes an electrical generator having an outer shell directly connected to the rotor to provide electrical power from the wind regardless of its direction and without the need for gearing or other interconnection between the rotor blades and the generator. Specialized electrical circuitry connected to the generator output provides a constant DC voltage source suitable for operating DC equipment, despite variations in wind speed.

### BACKGROUND

1. Field

The present invention relates to wind powered generating systems and more particularly to such systems employing Savonius rotors.

2. Prior Art

A number of prior art wind powered generating systems have been made which use Savonius rotors or use a fixed shaft. The inventions are described briefly below:

U.S. Pat. No. 4,515,653 illustrates a DC generator in which the rotor may be locked. However it fails to have a Savonius-type wind power apparatus used as the power source.

U.S. Pat. No. 4,715,776 illustrates a Savonius-type wind powered generator; however, it fails to have a fixed shaft.

U.S. Pat. No. 4,784,568 illustrates a Savonius-type wind powered generator; however, it fails to have a fixed shaft.

U.S. Pat. No. 5,391,926 illustrates a wind turbine suitable for use in high speed winds; however, it fails to have a fixed shaft and it does not have the turbine connected to the outside of the casing of the generator.

U.S. Pat. No. 6,261,315 illustrates a wind power motor with blades attached to the outside of a rotor drum; however, the drum is not the generator casing.

The simplicity and cost savings gained by direct connection of a Savonius rotor to the outer casing of a generator is not disclosed in any of the prior art patents, nor do any of these patents disclose the circuitry required to make such a system useful and practical.

### BRIEF DESCRIPTION OF THE FIGURES

FIG. 1 is a top cross sectional view of the present invention which incorporates a Savonius rotor directly connected to the outer shell of a generator. The rotor and the outer shell of the generator rotates about a centrally located stationary shaft within the generator.

FIG. 2 is a perspective view of the present invention showing the Savonius rotor blades attached to the outer shell of the generator.

FIG. 3 is a top cross sectional view of the generator showing permanent magnets attached to the inside of the outer shell of the generator and windings wound about a fixed armature in the center of the generator.

FIG. 4 is a schematic diagram of an alternator showing windings for the armature, and their interconnections as well as permanent magnets which are positioned to present alternating North and South poles to these armature windings.

FIG. 5 is a “lossless” automatic voltage adjustment circuit to provide a constant output voltage despite variations in wind speed.

FIG. 6 is a side view of a dual Savonious rotor and generator system having first and a second Savonious rotor is designed to provide power from very low velocity winds of 1 to 2 knots per hour up through wind velocities of 60 knots per hour.

FIG. 7 is a side view of the system shown in FIG. 6 with a protective closure positioned about the second Savonious rotor to shield the rotor from high velocity winds.

FIG. 8 is a block diagram of a system for sensing the rotor speeds, activating protection of the second light weight system and switching the active generator to an overall system output port.

### SUMMARY

It is an object of the present invention to provide a means of generating DC power regardless of wind velocity.

It is an object of the present invention to provide a wind generating system which does not require gearing or other special connections between the rotor and the generator.

It is an object of the present invention to provide a reliable DC generating system which eliminates the need for commutation, or slip rings.

It is an object of the present invention to provide a wind powered electrical generating system which can be manufactured at low cost by eliminating gearing and other power drive interconnections.

It is an object of the present invention to provide a wind powered electrical generating system which will maintain a sufficiently high output voltage to allow battery charging with low wind velocities.

A Savonius rotor generating system that includes a generator with an outer shell is formed by directly connecting the rotor to the outer shell of the generator. This system is capable of producing electrical power from the wind regardless of its direction and without the need for gearing or other interconnection between the rotor blades and the generator. Specialized electrical circuitry connected to the generator output produces a constant DC voltage source suitable for operating DC equipment, despite variations in wind speed.

The windings within the generator are wound on a centrally located armature, while the permanent magnets, which are mounted to the generator's outer shell, are rotated by the Savonius rotor about the centrally located armature windings. This arrangement eliminates the need for slip rings or a commutator. These windings will produce an AC output which can be converted to DC by rectification or switching. The AC output is fed to a variable transformer that is automatically adjusted to provide a relatively constant output voltage which is sufficient to charge a battery regardless of the wind speed.

### DETAILED DESCRIPTION OF THE INVENTION

FIG. 1 is a top cross sectional view of a first Savonius rotor having a plurality of blades, such as blade 2, which are connected to the outer shell 3A of a first generator 3. The first Savonius rotor and the outer shell of the first generator rotate together about the fixed position of a centrally located shaft 3B contained within the generator 3. One of the advantages of a Savonius rotor is that it will rotate regardless of the direction of the wind. There is no need for a vane to direct a propeller into the wind, as is usually required with most wind generators.

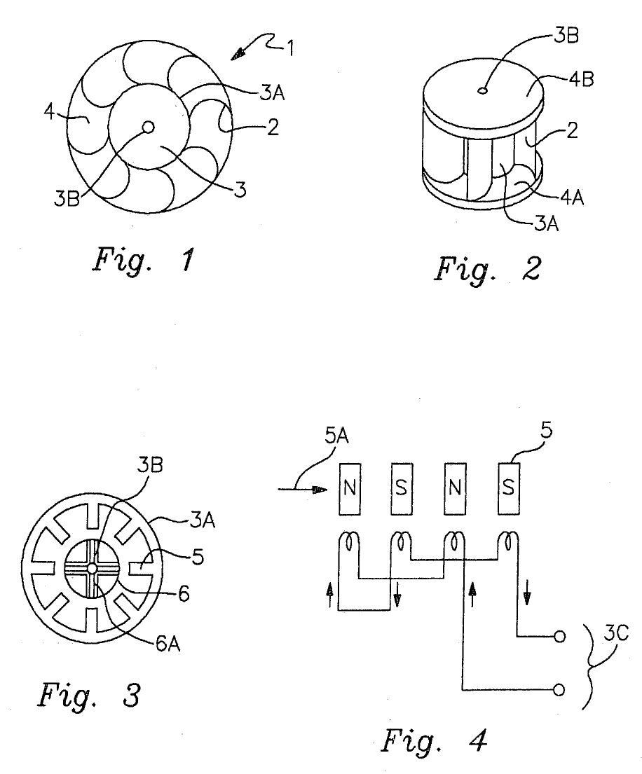

FIG. 2 is a prospective view of the Savonius rotor showing the blades to be connected at their top to a top rotor disc 4B and at their bottom to a bottom rotor disc 4A. The inside edges of the blade are connected to the outer shell of the generator 3A.

An alternate configuration to that of FIG. 2 is one in which the top and bottom disc are removed and the only support for the blades is their connection to the outer shell of the rotor 3A. The configuration shown in FIG. 2, which includes the top and bottom discs, has the advantage of much greater strength and therefore can withstand high wind velocities, such as those above 15 knots per hour, but it has the disadvantage of greater weight, making it more difficult to operate in low wind velocities such as those below 5 knots per hour.

FIG. 3 is a top cross section view of the generator showing a plurality of permanent magnets such as magnet 5 and a centrally located armature 6 which has a plurality of windings, such as winding 6A. The armature 6 is mechanically mounted on the generator shaft 3B. Both the armature and the shaft are held in a fixed position while the magnets and outer shell are caused to rotate about the stator by the wind. While rotating, the field of the magnets cuts the windings on the stator and generates an electrical voltage in the windings.

FIG. 4A is a schematic diagram of the connection of the windings in the generators. This Figure shows permanent magnets arranged to present to the windings alternate North and South poles. A plurality of windings are placed in close proximity to the magnets. The direction of movement of the magnets with respect to the windings is indicated by the directional arrow 5A. The direction of the current produced by this movement of the magnets is indicated by the arrows next to the leads coming from each winding.

These leads are interconnected such that the current from the winding are aiding. The final terminals of this interconnection occur at 3C, which represents the output of the generator. With this interconnection, the generator is an alternator that provides an alternating current at terminals 3C. The way in which alternating current is produced in this generator can be seen by noting that as each North pole passes by a winding, it produces a voltage with a first plurality. As the next magnet presents a South pole to the same winding, a voltage is produced with opposite plurality. Since the windings are connected to be aiding, there will first be a voltage produced with one plurality, and then as the next pole passes a voltage with the opposite plurality will be produced, resulting in the alternating voltage at output terminals 3C.

The alternating voltage at the terminals at 3C can be converted to a direct voltage in several ways. One way is to use a rectifier, while another is to use a switching or commutation circuit which continually switches the positive output voltage of the winding to a first output lead and the negative output voltage to a second output lead, thereby producing a DC voltage. Commutation can be achieved mechanically, but preferably is done electronically to provide for greater life of the equipment.

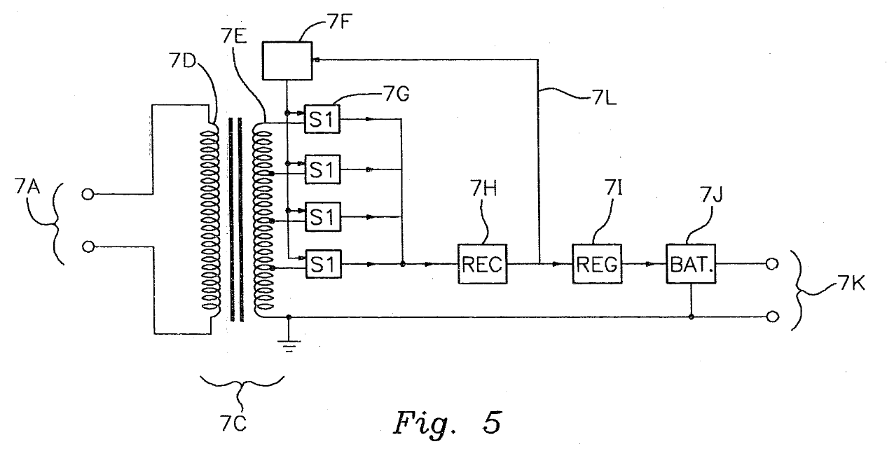

FIG. 5 is an automatic voltage adjustment circuit designated to provide a constant output voltage despite variations in wind speed. As wind speed changes, the voltage generated in the coils of the generator rises and falls with the wind speed. Unfortunately, if no correction is made, the wind speed may fall to a level that produces a voltage unsuitable for operating a device or charging a battery. This problem can be eliminated with the circuit shown in FIG. 5. This circuit comprises input terminals 7A, a transformer 7C, having a primary 7D and a secondary 7E. The secondary 7E is tapped and each tap is connected to a switch, such as switch 7G, with each switch having an input on an output port. The input port of each switch is connected to a tap while the output ports of all the switches are combined and fed to a switching converter circuit 7H which in turn, feeds a voltage regulator 71. The output of the regulator may be fed to a battery 7J which feeds output terminals 7K. A controller 7F actuates only one of the switches at one time. The selection of the switch that is actuated is determined by a feed back voltage from the output of the rectifier through line 7L.

In the operation of this circuit, a varying alternating voltages is fed from the input terminals 7A to the primary 7D of the transformer 7C. Various output voltages are produces at the different taps on the secondary 7E of this transformer. The controller 7F, receives through line 7L, the output voltage from rectifier 7H. If, for example, the desired output voltage is 12 volts, and the voltage produced on the second tap of the transformer is above, but close to 12 volts, the switch connected to this tap will be turned on by the controller so that the output voltage nearly approximates the desired 12 volts. Whatever tap on the secondary that has a voltage necessary to produce a desired DC voltage at the output of the rectifier will be selected. The voltage received from the secondary of the transformer via a switch is rectified in rectifier 7H and is then transmitted to voltage regulator 71 to reduce ripple and more precisely produces the desired output voltage. As long as there is wind above 2 knots per hour, output voltage can almost always be produced that is capable of charging a battery, and when there is sufficient wind power, the output can also be used to power an electrical device directly.

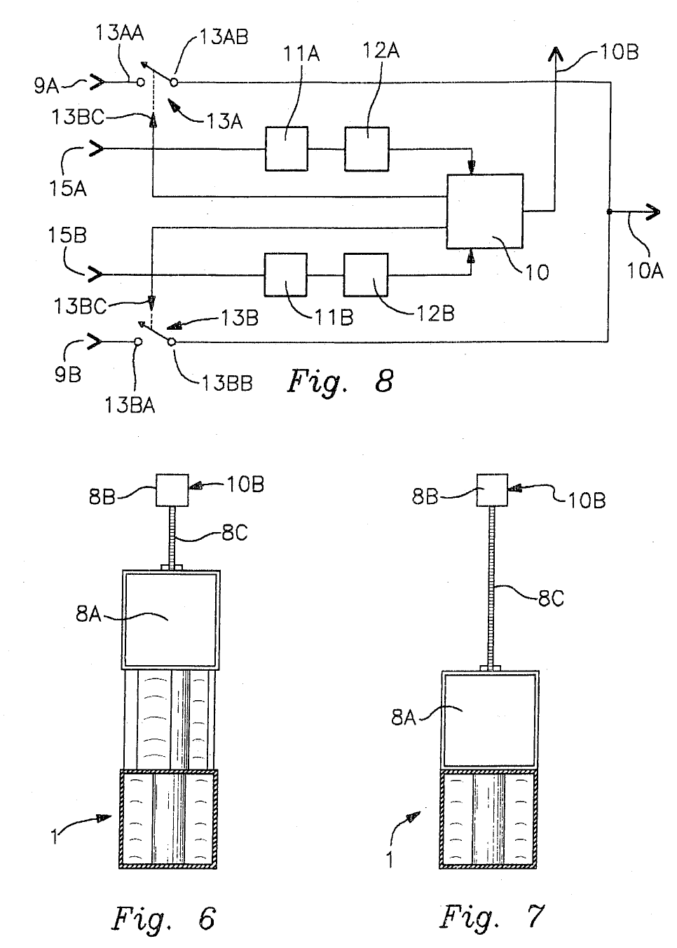

FIG. 6 is a side view of a dual Savonious rotor and generator system having a first and a second Savonious rotor which are designed to provide power from very low velocity winds of 1 to 2 knots per hour up through wind velocities of 60 knots or more per hour. This is accomplished by combining the Savonious generating system described above, which is referred to as system 1, with a second Savonious rotor generating system 8, where the second system is designed specifically to operate and produce power at low wind velocities. To provide a system that operates at low velocity requires light weight blades, housing and magnets as well as low resistance bearings. The rotor discs 4A and 4B shown in FIG. 2 may be eliminated. Thin wall aluminum is typically used to form the blades and housing. The low resistance bearings can be used because of the light weight system they carry. Other refinements, such as blade shape, can be added, but the light weight construction and low resistance bearings are of prime importance in continuously providing power at low wind velocities. The light weight means there is little inertia or bearing resistance that the wind must overcome. These factors make it possible to have the blade moved by winds of low velocities, such as velocities below 5 knots per hour, but such light weight construction places severe limitations on the upper wind velocity that can be withstood by this second light weight system. For practical systems, the safe upper wind velocity is often as low as 15 knots. Exceeding this limit can result in blade distortion and even destruction. The same is true for the housing and bearings.

However, the light weight system can be protected automatically when high velocity winds appear. To do this, a cylindrical shaped cover 8A is automatically placed about the blades when the winds exceed a specific value such as 15 knots. To aid in insuring a close fit of the cover about the rotor, the axis of revolution of the rotor and the cover may be colocated. As can be seen in FIG. 6, the cover 8A is positioned above the rotor system 8 when winds are at a velocity which can be accommodated by system 8. When potentially damaging winds are present, the cover 8A is driven down and about the blades of 8 by a drive motor 8B and linkage 8C located above the cover 8A. The “down” position of the cover is shown in FIG. 7. The drive linkage 8C connects the drive motor to the cover. This linkage may take many forms, but a very suitable form is a screw drive system, where the motor turns a threaded shaft through a nut located on the motor chassis to cause the shaft to advance or retreat, depending on the direction of rotation of the motor. In this drive system for the cover, the cover can be driven downward to protect the rotor system 8 or withdrawn upwardly to allow the rotors to rotate, simply by changing the direction of the drive motor.

FIG. 8 shows a system for controlling the switching of the DC outputs from the two systems to a single overall system output port and for sensing the rotor speeds and drawing the protective cover over the light weight rotor when the wind velocities are excessive for that rotor.

This system comprises an input port 9A which receives the DC output from generating system 1, an input port 9B which receives the output from generating system 8, an input port 15A which receives an AC signal from generating system 8, an input port 15B which receives an AC signal from generating system 1, a first switch 13A having an input port 13AA, an output port 13AB and a control port 13AC, a second switch 13B having an input port 13BA, an outport port 13BB and a control port 13BC, a first half wave rectifier 11A, a second half wave rectifier 11B, a first counter and clock 12A, a second counter and clock 12B, a control means 10, a control line 10B from 10 to the drive motor 8B, an overall DC system output port 10A, a line 9C carrying the current from the output of port 13AB of switch 13A to the overall system output port 10A, a line 9D carrying the current from the output port 13BB of switch 13B to the overall system output port 10A, a first switch control line 14A from control means 10 to control port 13BC of switch 13B, and a second switch control line 14B from the control means 10 to control port 13BC of switch 13B. In the operation of the system shown in FIG. 8, the second generating system 8 includes a voltage adjustment, rectification and regulation system similar to the one shown in FIG. 5 to provide a regulated DC output which is delivered to port 9A of the control system of FIG. 8. Similarly, the rectified and regulated output of generating system 8 is delivered to port 9B of control system shown in FIG. 8.

The control system accepts at port 15A a sample of the raw AC power output of the alternator in generating system 8 as well as a sample of the raw AC output from the alternator in generating system 1 at port 15B. The AC power from generating system 1 is taken from port 15A and fed through the half wave rectifier 11A which feeds its output to counter and clock 12A, the output of which is fed to the control means 10. The half wave rectified signal into 12A is a unipolar, pulsed signal with a repetition rate proportioned to the rotational velocity of the rotor in system 8. This is true because the alternating current in the alternator in system 8 produces either a positive or a negative pulse as it passes a pole. When this signal is half wave rectified, the pulses are unipolar and its rate is proportioned to the rate at which the magnets are revolved past the windings in the armature, which of course, is proportional to the rotational velocity of the alternator housing.

The control means 10 can manipulate this input signal in several ways to activate the drive motor for the protective cover 8A. One way is to convert the pulse train representing the rotor velocity to an analog signal by integrating it and then passing it to a DC comparitor (operational amplifier) where it is compared with a fixed voltage representing the maximum velocity at which the rotor of system 8 can function. The velocity can also be ascertained digitally and the digital output compared to a digital signal representing the maximum velocity to again produce a signal to actuate the motor.

This approach to activating the motor 8B is certainly a fail safe method because it directly reads the rotors velocity and acts to protect the rotor, however, it requires a latching system which holds the cover down, because as the cover is put in place, the rotors velocity drops, which makes it appear as thought the wind velocity had dropped and that would tend to lift the cover.

If the cover is electrically latched down by cutting power to the drive motor, the upward drive signal is cut off, then the identical frequency measurement system formed by 11B and 12B which measures the velocity of the rotor in system 1 can be used to infer the speed of the rotor in system 8 and release the cover for generating system 8 when the wind velocity drops to a safe level. However, a simpler system is to simply use the speed of the heavy rotor in system 1 only, and determine wind velocity for both rotors and also use this velocity to activate the protective cover. This approach eliminates the need for 11A and 12A. However, both rotor velocity determining systems including the components 11A, 11B, 12A and 12B can be used if a back up system is desired to insure no damage occurs to the rotor in system 8 from high wind velocities.

The DC power from generating system 8 is delivered to input port 9A where it is transmitted through switch 13A and supplied on line 9C to system output port 10A. Similarly the DC power from generating system 1 is delivered to input port 9B where it is transmitted through switch 13B and supplied on line 9D to system output port 10A. The controller using the rotor speed information derived from the counter and clocks 11A, 11B, 12A, and 12B activate either switch 13A or 13B, depending on which generating system is producing power. The generator which is delivering power is derived from the rotor speed information already supplied to control means 10. The control signals are delivered to the switch control lines 14A and 14B and to the switch control ports 13AC and 13BC. The switching from one generator to another is set to be at a selected wind velocity, such as 10 knots per hour. It is possible to parallel the output of both generators when they are both producing power. This requires that both switches be closed by the control means 10. In some cases, when paralleling, the two generators, additional control circuitry is required to insure that both generating systems are sharing the load; however, there is a natural tendency for each rotor to share the load because if one rotor's load is light, it tends to speed up, raise its output voltage which, in turn tends to load this system more and slow it down. This occurs even with voltage regulation as the regulation is not perfect and the higher voltage generator tends to deliver a slightly higher voltage and more current and thus accept a greater load.

There are many possible control systems which may be devised for the dual rotor system. For example, the voltage level rather than the frequency of the AC signal from the generators can be used to determine the rotational velocity of the rotors. Higher voltage means a higher rotational velocity. Many other alternatives may be devised by those skilled in the art to implement the present invention once its operation has been disclosed. Such alternatives are considered to be within the spirit and scope of the present invention.

Having described my invention, I claim:

1. A wind powered electrical generating system comprising:
(a) a first Savonious rotor, said rotor being caused to rotate when subject to the wind,
(b) a first electrical generator which includes a rotatable housing and a fixed position armature, said first generator producing an electrical output when said housing is rotated about said armature, said first Savonious rotor being connected to said housing causing said housing to rotate and causing said first generator to produce power when said first rotor is subject to wind.

2. A wind powered generating system as claimed in claim 1 wherein said housing includes permanent magnets and said armature includes windings with ends, the field from said permanent magnets cutting the windings when said housing and magnets are rotated by said first Savonious rotor to induce current flow in said armature windings, the ends of said windings which are held with the armature in a fixed position forming the output terminals of said generating system on which the current from said generating system is delivered without the need for slip rings or commutation.

3. A wind powered generating system as claimed in claim 2 further comprising an automatic voltage adjustment system (AVAS) which includes an input port and an output port, said AVAS accepting at its input port the output voltage of said first electrical generator, which varies with wind speed, and providing at its output port a voltage that remains above a specified voltage despite the variations in the output voltage from said first generator, said AVAS comprising:
(a) a transformer having a primary and a secondary, said primary being connected to receive the output power from said output terminal of said first generator, and said secondary being tapped,
(b) a common output bus, said bus being connected to the output port of said AVAS,
(c) switching means for selectively connecting each tap on the secondary individually to said common bus, and
(d) means for sensing the voltage on said common bus and for activating said switching means to connect said common bus to the tap on said secondary that provide a voltage that is closest to, but is also higher than said predetermined voltage.

4. A wind powered generating system as claimed in claim 3 further comprising a first rectifier and having an input port and an output port, said first rectifier accepting at its input port from said AVAS output port, the AC power from said AVAS, converting it to DC power, and delivering it to said output port of said first rectifier.

5. A wind powered generating system as claimed in claim 4 further comprising a regulator, said regulator having an input port and an output port and accepting at its input port the DC power from said rectifier output port to regulate it and provide an output voltage at a selected DC output voltage which is delivered to the output port of said regulator.

6. A wind powered generating system as claimed in claim 3 further comprising:
(a) a second Savonious rotor, said second rotor being generally cylindrical and having an axis of revolution, said second rotor being caused to rotate when subject of the wind,
(b) a second electrical generator which includes a rotatable housing and a fixed position armature, said second generator producing an electrical output when said housing is rotated about said armature, said second Savonious rotor being connected to said housing to rotate said housing and causing said second generator to produce power when said second rotor is subject to the wind.

7. A wind powered generating system as claimed in claim 6 wherein said second Savonious rotor and the housing of said second electrical generator are lighter than said first Savonious rotor and the housing of said first electrical generator, to permit said second Savonious rotor and housing to function in wind below a first selected wind velocity.

8. A wind powered generating system as claimed in claim 7 wherein said first selected wind velocity is 5 knots per hour.

9. A wind powered generating system as claimed in claim 7 further comprising a protective cover for covering and protecting said second Savonious rotor in winds above a second selected wind velocity.

10. A wind generating system as claimed in claim 9 wherein said second selected wind velocity is 15 knots.

11. A wind powered generating system as claimed in claim 9 wherein said protective cover is cylindrical in shape and is positioned to surround said second Savonious rotor.

12. A wind power generating system as claimed in claim 11 wherein the axis of revolution of said protective cover is generally colocated with the axis of revolution of said second Savonious rotor.

13. A wind powered generating system as claimed in claim 11 further comprising means for positioning said protective cover about said second rotor, and removing said protective cover from about said second Savonious rotor in response to wind velocities above and below, respectively said second selected value of wind velocity to protect said second rotor in winds having a velocity that will damage said second Savonious rotor and to permit said rotor to rotate in wind having a velocity that will not damage said second Savonious rotor.

14. A wind powered generating system as claimed in claim 13 wherein said means for positioning said protective cover includes a reversible motor, said motor being driven in one direction to place the protective cover about said second rotor and in the reverse direction to withdraw said cover from about said second rotor.

15. A wind powered generating system as claimed in claim 13 further comprising a controller means, said controller means receiving at least a sample of raw AC from the output of said first generating system, which has a frequency proportional to the rotational velocity of the second Savonious rotor, said controller means including accepting said AC signal from said first generating system and producing a control signal to actuate said motor to put said cover in place about said second rotor or to remove said protective cover when said wind velocity is respectively above or below said second selected wind velocity.

16. A wind powered generating system as claimed in claim 6 further comprising a second AVAS with an input and output port, a first and second switch and an overall system output port, the input port of the second AVAS being connected to the output of said second electrical generating system to provide regulated DC power at the second AVAS output port, said first switch and second switches each having individual control, input and output ports, the input port of said first switch being connected to the output port of the first AVAS and the input port of the second switch being connected to the output port of the second AVAS, and the outputs of the first and second switches being connected together and to said overall system output port to provide the output of the first, or the second, or both the first and second electrical generating systems to the overall system output port.

17. A wind powered generating system as claimed in claim 16 in which said controller includes switch control output lines connected to the control ports of said first and second switches, said controller producing outputs on said control lines to actuate said switches in accordance with said first selected velocity of said second Savonious rotor to direct the power from at least one of the generating system that is producing power to the overall system output port.
